(19) United States
(12) Patent Application Publication
(10) Pub. No.: US 2022/0187830 A1
(43) Pub. Date: Jun. 16, 2022

(54) MODULAR DEPLOYMENT AND RETRIEVAL SYSTEM FOR UNMANNED SUB-CARRIERS

(71) Applicants: Shiwei Liu, Lehi, UT (US); Tianye Wang, Halifax (CA); Ben Hatfield, Halifax (CA); Lishao Wang, Halifax (CA); Xiaoge Cheng, Beijing (CN); Fred Lu, Halifax (CA)

(72) Inventors: Shiwei Liu, Lehi, UT (US); Tianye Wang, Halifax (CA); Ben Hatfield, Halifax (CA); Lishao Wang, Halifax (CA); Xiaoge Cheng, Beijing (CN); Fred Lu, Halifax (CA)

(21) Appl. No.: 17/547,499

(22) Filed: Dec. 10, 2021

Related U.S. Application Data
(60) Provisional application No. 63/123,514, filed on Dec. 10, 2020.

(51) Int. Cl. G05D 1/02; G05D 1/00; G08G 3/00

(52) U.S. Cl. CPC G05D 1/0206; G08G 3/00; G05D 1/0027

(57) ABSTRACT

The present disclosure provides a system for autonomously controlling a fleet of carrier platforms on a water body surface, each carrier platform hosting and being configured to deploy and retrieve one or more sub-carriers for autonomously carrying out operations in a marine environment. The one or more carrier platforms and sub-carriers of the system each have navigation and positioning modules for coordinating movements and are also centrally managed via an intelligent central control system from which the operations of the fleet can be monitored and controlled. The present invention solves the retrieval issue presented by deploying unmanned sub-carriers in complex real-world environments. The invention provides for a modular retrieval system for unmanned sub-carriers.

### FIELD OF INVENTION

The present invention relates generally to the field of autonomous vehicle systems. More specifically, the present invention relates to a modular deployment and retrieval system for unmanned sub-carriers.

### BACKGROUND

Use of unmanned sub-carriers is becoming increasingly common and has many advantages across a variety of industries, particularly for performing offshore operations.

While the upfront cost is greater than for hiring workers, the reduced costs and limitations as compared with manual labour make the use of unmanned vehicles an attractive proposition. When using unmanned vehicles crews do not need to be paid and kept in good working conditions and the work limits of divers and human error in all kinds of operations are removed. Offshore operations become less prohibitively expensive and can be carried out with greater frequency.

A switch to relying more heavily on unmanned sub-carriers would also facilitate a personnel transition for marine based organizations, that could instead hire personnel for controlling such operations and leaving the manual labour to the systems.

The problem is that currently available technology requires human personnel to perform the deployment and retrieval operations for the unmanned sub-carriers due to the complex nature of real-world deployment environments. This requirement negates the benefits of using unmanned sub-carriers in the first place and the issue increases with scale, as large-scale deployment of sub-carriers over large areas requires correspondingly large significant investment in sub-carrier deployment and retrieval.

It is within this context that the present invention is provided.

### SUMMARY

The present disclosure provides a system for autonomously controlling a fleet of carrier platforms on a water body surface, each carrier platform hosting and being configured to deploy and retrieve one or more sub-carriers for autonomously carrying out operations in a marine environment. The one or more carrier platforms and sub-carriers of the system each have navigation and positioning modules for coordinating movements and are also centrally managed via an intelligent central control system from which the operations of the fleet can be monitored and controlled.

Aspects of the present invention provide for varying levels of automation, algorithm integration, sub-carrier classification, positioning modules, sensor packages, information integration, data transmission, data analysis, and so forth.

Thus, according to one aspect of the present disclosure there is provided a deployment and retrieval system for unmanned sub-carriers, the system comprising: one or more carrier platforms, each carrier platform comprising: an array of sensors, the array of sensors including a GPS module; a wireless communications module; propulsion and steering means; one or more docking stations for holding, deploying, or retrieving an unmanned sub-carrier; and a controller equipped with navigation and positioning modules configured to autonomously navigate the carrier platform across a water body surface.

The system further comprises: one or more unmanned sub-carriers, each sub-carrier being docked on a carrier platform and comprising: an array of sensors, the array of sensors; a wireless communications module; propulsion and steering means; and a controller equipped with navigation and positioning modules configured to autonomously navigate the sub-carrier and carry out operations in a marine environment.

The system further comprises an intelligent central control system, the central control system comprising one or more servers in wireless communication with each of the one or more carrier platforms and one or more of the sub-carriers, and being configured to receive navigation, positioning, and mission data from the one or more carrier platforms and sub-carriers and to coordinate the movements and operations of the one or more carrier platforms and sub-carriers.

In some embodiments, the one or more sub-carriers comprise aerial drone sub-carriers in the form of unmanned aerial vehicles, UAVs.

In some embodiments, the one or more sub-carriers comprise water surface sub-carriers. The water surface sub-carriers may include unmanned surface vehicles, USVs. The water surface sub-carriers may also include smart buoys.

In some embodiments, the one or more sub-carriers comprise underwater carriers in the form of remotely operated vehicles, ROVs.

In some embodiments, the intelligent central control system comprises a data rendering module configured to provide real time mission data displays and tracking information displays for the carrier platforms and sub-carriers on a user interface.

In some embodiments, the intelligent central control system comprises a data analysis module configured to track and log the routes and operations of the carrier platforms and sub-carriers based on the navigation, positioning, and mission data received and to predict potential problems and intelligently co-ordinate said carrier platforms and sub-carriers accordingly.

In some embodiments, one or more of the carrier platforms comprise nest docking stations for deploying and retrieving aerial drones.

In some embodiments, one or more of the carrier platforms comprise small vessel docking stations for deploying and retrieving unmanned surface vehicle sub-carriers.

In some embodiments, one or more of the carrier platforms comprise underwater cages for deploying and retrieving underwater sub-carriers.

In some embodiments, the central control system includes an interface where an operator may input instructions for any one of: inputting tasks, controlling the level of automation, and automating tasks of the carrier platforms and sub-carriers.

### BRIEF DESCRIPTION OF THE DRAWINGS

The present invention is illustrated and described herein with reference to the various drawings. The drawings illustrate example embodiments of the present disclosure and cannot be considered as limiting its scope.

FIG. 1 is a block diagram illustrating an overall system according to some example embodiments of the present disclosure.

FIG. 2 is a block diagram illustrating an intelligent central control module of the system, according to some example embodiments of the present disclosure.

FIG. 3 is a block diagram illustrating data chain system, positioning system, and navigation system modules according to some example embodiments of the present disclosure.

FIG. 4 is a block diagram illustrating a carrier platform in communication with the data chain system modules, according to some example embodiments of the present disclosure.

FIG. 5 is a block diagram illustrating the carrier platform in communication with an aerial sub-carrier, according to some example embodiments of the present disclosure.

FIG. 6 is a block diagram illustrating the carrier platform in communication with a water-surface sub-carrier, according to some example embodiments of the present disclosure.

FIG. 7 is a block diagram illustrating the carrier platform in communication with an underwater sub-carrier, according to some example embodiments of the present disclosure.

FIG. 8 is an illustration of a system according to the present disclosure in operation deploying and retrieving various sub-carriers on a body of water.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The capabilities of sensor technologies such as light detection and ranging (LIDAR), mm wave radar, and Passive infrared (PIR) have progressed to a point where unmanned sub-carriers can outperform human personnel in many situations in the marine environment if they can be effectively deployed to and retrieved from the locations they need to operate in.

With the development of effective low orbit communications satellite systems, ocean signal coverage has also improved dramatically and will continue to do so, opening up a wide range of opportunities for autonomous offshore systems.

The present disclosure provides one such system managed by an intelligent central control module which is capable of autonomously deploying and retrieving various types of unmanned sub-carriers from a carrier platform for extended offshore operations without the need for human personnel.

The system will likely comprise multiple carrier platforms equipped with different sub-carriers for carrying out various operations in various marine contexts. The carrier platforms and sub-carriers can be controlled remotely by an operator, completely autonomously, or in a combination of the two—the level of automation and the automation of new tasks can be controlled via an intelligent central control system.

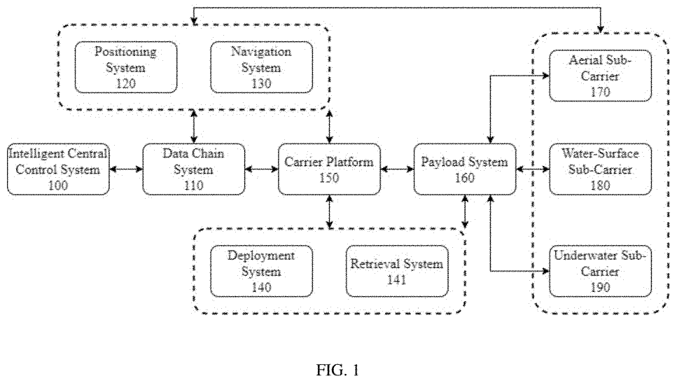

With reference to FIG. 1, a block diagram of an exemplary embodiment shows an overall architecture of a modular retrieval system for unmanned sub-carriers.

The exemplary system includes an intelligent central control system module 100, a data chain system module 110, a positioning system module 120, a navigation system module 130, a deployment system module 140, a retrieval system module 141, a number of carrier platforms 150, a payload system 160, a number of aerial sub-carriers 170, a number of water-surface sub-carriers 180, and a number of underwater sub-carriers 190.

The central control system module 100 may for example be a central server or base station from which the overall operations of a fleet of carrier platforms 150 can be controlled. It may include an interface for sending various commands to individual sub-carriers via the data chain system 110 over a wireless network, for example a low-orbit satellite communications network providing ocean coverage for communicating with the carrier platforms 150.

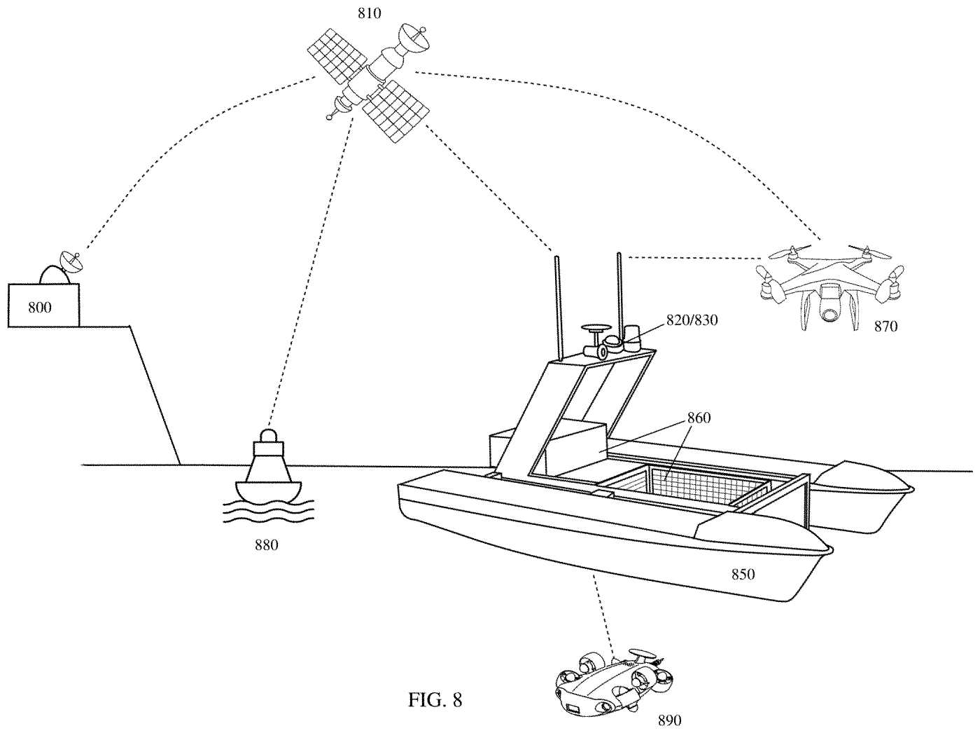

A carrier platform 150 may be an unmanned marine vessel or “unmanned surface vehicle” (USV) such as a small boat, equipped with an array of sensors for tracking its environment and geographical position (see FIG. 8), the sensors will usually include a GPS sensor. Naturally the carrier platform vessels also have means of propulsion and steering autonomously.

The data chain system 110 is also configured to receive and log position updates and other updates received from the one or more carrier platforms 150 and forward these to positioning system 120 and navigation system 130. These two modules coordinate using the received information to managed routes and movements of the various carrier platforms 150 managed by the system controller 100.

In other examples, instead of a centralized positioning and navigation system, each carrier platform is equipped with its own independent positioning and navigation system and they communicate with one another and with the central control system via the data chain system.

Either way, the navigation and positioning systems comprise algorithms that ensure that carrier platforms 150 take the most efficient routes and do not collide with one another, it also facilitates efficient responses to instructions entered from an operator.

For example, an operator may receive a request or notification that a marine operation needs to be performed at a certain location. The operator can then enter into the system interface of the central control module 100 that a carrier platform is required at that location, and the positioning system 120 and navigation system 130 will coordinate to determine the closest available carrier platform 150 with the appropriate sub-carrier for carrying out the operation, and will route it to the location.

Each carrier platform 150 is also equipped with deployment and retrieving apparatus for various kinds of sub-carriers—for example a nest for an aerial drone sub-carrier, a dock for a water-surface sub-carrier, and a cage configured to be deployed underwater for releasing and retrieving an underwater drone sub-carrier. These mechanisms make up the payload system 160, and they are controlled by a deployment system 140 and retrieval system 141 of the vessel controller, which uses the array of sensors to locate and track the sub-carriers, then wirelessly communicates with them to instruct them when to end their operations and return to the platform 150.

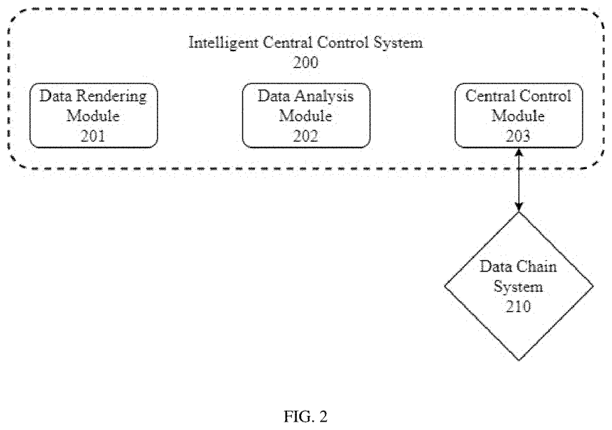

With reference to FIG. 2, a block diagram of an example embodiment of the intelligent central control system 200 is shown in more detail. In the present example, the central control system module comprises a data rendering module 201, a data analysis module 202, and a central control module 203 which communicates with the data chain system.

The data rendering module 201 provides for and displays mission data for the various carrier platforms and sub-carriers currently deployed on a given body of water or in a geographical region. The mission data can be received from available sources including the positioning system, navigation system, carrier platforms, sub-carriers, and so forth.

The mission data can include but is not limited to: real-time maps with the location of each carrier platform marked and updated in real time, vector graphics indicating the intended routes and future positioning of the various carrier platforms, navigation information such as weather conditions and other environmental factors, status updates from the various carrier platforms and their sub-carriers such as battery levels and damage and wear etc, feedback information on the vessels, sub-carriers and their operations.

The data analysis module 202 provides for data storage, data analysis, early problem detection, problem resolution, mission monitoring, and so forth. For example, the positions and routes of each carrier platform and its associated sub-carriers may be recorded in a log history for that carrier and stored in a database managed by the data analysis module. The information is also analyzed in real time by an intelligent algorithm of the data analysis module designed for managing trajectories and predicting the status of the various deployed vessels in a form of “water AI”.

The central control module 203 communicates with the data chain system 210 and provides for mission control, inputting tasks, controlling the level of automation, automating tasks, and so forth. An operator can thus control which tasks require human control and which are performed on a regular basis autonomously. The control module broadcasts these instructions to whichever carrier platforms and sub-carriers are designated by the operator.

The intelligent central control system may not necessarily require a user to be at a central location to access it. Indeed, a user may be able to access and interface with the system via a water Al platform using application software installed on any wireless device such as may be a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

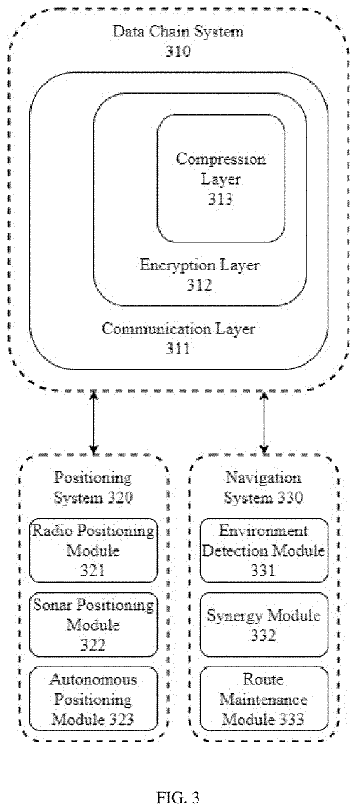

With reference to FIG. 3 a block diagram of the data chain system 310 is shown in more detail. In this example embodiment the data chain system 310 comprises: a communication layer 311 contained within an encryption layer 312, which in turn is contained within a compression layer 313.

The data chain system 310 manages communications of the system sent over the wireless network, forming the bridge between the various carrier platforms and sub-carriers; the intelligent central control system, and the positioning system 320 and navigation system 330.

As is known in the art, the communication layer 311 performs data communication and increases the data throughput, optimizes reliability and cost of sending and receiving communications.

As is also known in the art, the encryption layer 312 performs data encryption to protect the information sent and received in the communications.

As is also known in the art, the compression layer 313 performs data compression to improve response time of the system for sending and receiving communications.

In the present example, the positioning system 320 and navigation system 330 are independent systems of a sub-carrier.

The positioning system 320 comprises: a radio positioning module 321, a sonar positioning module 322, and an autonomous positioning module 323. The positioning system can contain a varying number of positioning modules dependant on the carrier, sub-carrier, and mission profile. In some example scenarios these positioning modules can be radar, sonar, autonomous (relying on internal sensor packages and onboard data processing software), and so forth.

The navigation system 330 comprises: an environment detection module 331, synergy module 332, and a route maintenance module 333. The navigation system will have: an environment detection module to obtain environment information from a variety of sensor packages, including but not limited to optical, laser, radar, and so forth; a synergy module to integrate local environment data obtained by sources with environment information collected from the environment detection module, which may be fed back to the central control system or onboard data processing software to monitor and improve precision, data collection, and so forth; and route maintenance module to integrate environment information from the environment detection module and synergy module to improve navigation, stability, and forth.

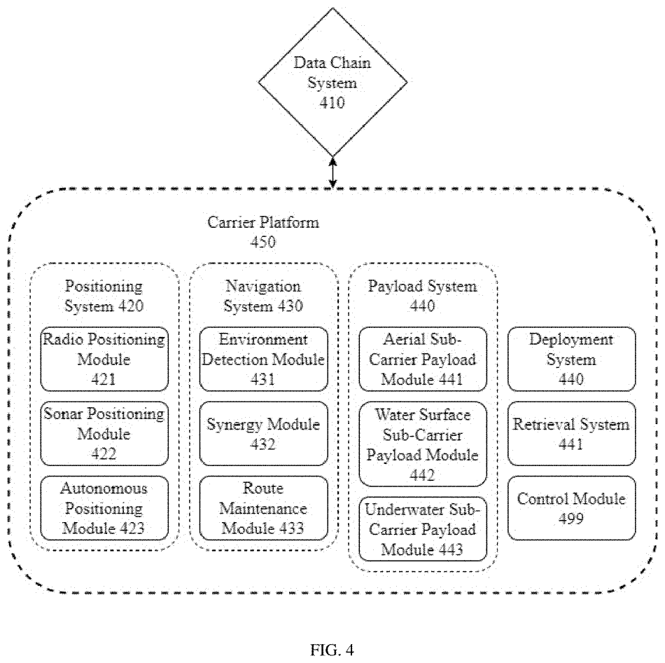

With reference to FIG. 4, an example embodiment a carrier platform 450 is shown in a block diagram. The carrier platform comprises a positioning system and navigation as described with reference to FIG. 3: a positioning system 420 comprising: a radio positioning module 421, a sonar positioning module 422, and an autonomous positioning module 423; a navigation system 430 comprising: an environment detection module 431, a synergy module 432, and a route maintenance module 433.

The carrier platform 450 also comprises a payload system 440 comprising: a number of aerial sub-carrier payload modules 441, a number of water-surface sub-carrier payload modules 442, and a number of underwater sub-carrier payload modules 443.

As mentioned above with reference to FIG.1, these payload modules are equipment for securing the unmanned sub-carriers to the carrier platform 450 during transit, releasing them at the location of a marine operation, and securing/docking them again once more once they have returned to the vessel. The payload modules may also comprise equipment for charging the power sources of the unmanned sub-carriers while they are docked, or even for repairing damage or replacing parts of the sub-carriers autonomously.

An aerial sub-carrier payload module 441 may for example be a nest station for an aerial drone. A water-surface sub-carrier payload module 442 may for example be a docking port with a mechanical/pneumatic/robotic arm for securing the water-surface sub-carrier to the carrier platform and then retrieving it from the water. An underwater sub-carrier payload module 443 may be a cage which is deployable underwater with a door that can be opened and close to release or secure the underwater sub-carrier.

The carrier platform 450 also comprises various processors for controlling these operations and interfacing with the rest of the system, these processors may be divided operationally into a deployment system 440, a retrieval system 441, and a control module 499—although those of skill in the art will appreciate that all of these modules may in fact comprise one processor or any number of processors.

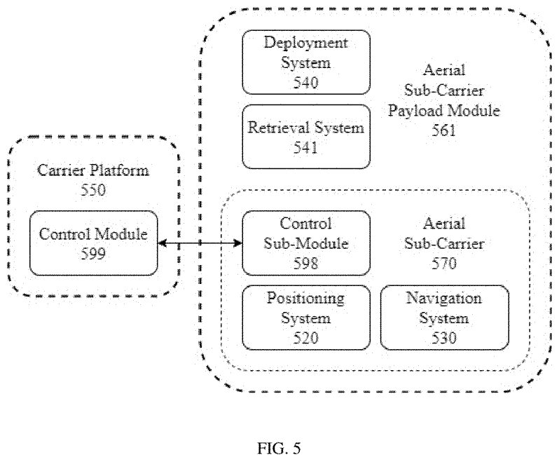

FIGS. 5-7 each show a block diagram of a different type of sub-carrier. As will be seen, each of the sub-carriers may have their own independent navigation, positioning, and control modules for allowing them to coordinate their operations with the carrier platforms and the rest of the system while they are deployed as described above.

With reference to FIG. 5, in one example embodiment an aerial sub-carrier payload module 561 comprises: a deployment system 540, retrieval system 541, and an aerial sub-carrier 570 comprising: a positioning system 520, a navigation system 530, and a control sub-module 598 which communicates with a control module 599 on a carrier platform 550.

The aerial sub-carriers may for example be unmanned aerial vehicles (UAVs).

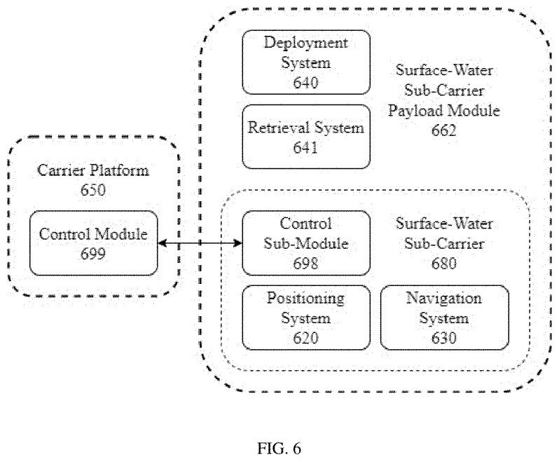

With reference to FIG. 6, in one example embodiment a water-surface sub-carrier payload module 662 comprises: a deployment system 640, retrieval system 641, and an water-surface sub-carrier 680 comprising: a positioning system 620, a navigation system 630, and a control sub-module 698 which communicates with a control module 699 on a carrier platform 650.

The water surface sub-carriers may for example be unmanned surface vehicles.

Alternatively, one or more of the water surface sub-carriers may be buoys. The buoys may act as monitoring stations.

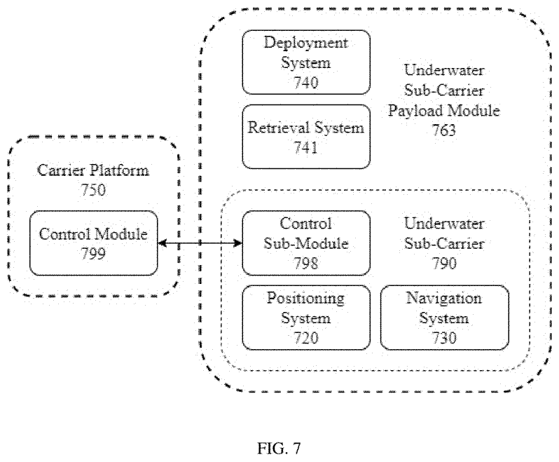

With reference to FIG. 7, in one example embodiment an underwater sub-carrier payload module 763 comprises: a deployment system 740, retrieval system 741, and an underwater sub-carrier 790 comprising: a positioning system 720, a navigation system 730, and a control sub-module 798 which communicates with a control module 799 on a carrier platform 750.

The underwater sub-carriers may for example be remotely operated underwater vehicles (ROVs).

FIG.8 is an illustration of an example system according to the present disclosure in operation deploying and retrieving various sub-carriers to carry out marine operations on a body of water.

As can be seen, the central control module 800 in the present case is a base station located on the shore of the body of water and in communication with the carrier platform 850 and its various deployed sub-carriers (aerial sub-carrier 870, surface sub-carrier 880, and underwater sub-carrier 890) via a low orbit satellite communications network which facilitates encrypted communications via a data chain system 810.

The carrier platform 850 is an unmanned surface vessel equipped with an array of environment and position sensing modules which from its independent positioning 820 and navigation modules 830, and which are in communication with a vessel controller.

Two example payload modules 860 are shown on the carrier platform vessel, a drone box nest for receiving and storing the aerial drone and a cage which may be lowered underwater to deploy and retrieve the underwater sub-carrier 890.

The system has nearly limitless applications for autonomous operations in marine environments depending on the type of sub-carrier deployed.

These applications include, but are not limited to:
Target object identification of fish, sea cucumbers, cages, and infrastructure.
Exploration of underwater environments and digital reconstruction for recreating the explored topographies.
Monitoring surveys: Underwater inspections of offshore facilities.
Environmental monitoring: surface garbage salvage, shore and fishing behaviour monitoring.
Governmental policy assessment surveys: Underwater Species Assessment to assist the Government formulate fisheries policies for the coming year.
Sediment detection: the search and marking of underwater sinkings.
Scientific sampling: Canadian government microplastics, offshore oil spill projects.

It should be understood that the operations of the intelligent central control module described herein may be carried out by any processor. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system for deployment and retrieval of unmanned sub-carriers have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

### STATEMENT OF INVENTION

In one aspect of the disclosed embodiments, a modular retrieval system for unmanned sub-carriers, comprising: an intelligent central control system, comprising: a data rendering module, a data analysis module, and a central control module; a data chain system, comprising: a communication layer, within contained an encryption layer, within contained a compression layer; a positioning system, comprising: a number of positioning modules; a navigation system, comprising: an environment detection module, synergy module, and route maintenance module; a number of carrier platforms, one platform including: a positioning system, a navigation system, deployment system, retrieval system, payload system, and control module; a number of sub-carrier payload modules, one sub-carrier module including: a deployment system, a retrieval system, and a sub-carrier; and a number of aerial, water-surface, and underwater sub-carriers, one sub-carrier including: a positioning system, navigation system, and control sub-module; wherein the data rendering module provides for and displays mission data, including real-time maps, positioning information, navigation information, environment information, feedback information, and so forth received from available sources including the positioning system, navigation system, carrier platforms, sub-carriers, and so forth; wherein the data analysis module provides for data storage, data analysis, early problem detection, problem resolution, mission monitoring, and so forth; wherein the central control module communicates with the data chain system and provides for mission control, inputting tasks, controlling the level of automation, automating tasks, and so forth; wherein the communication layer performs data communication, the encryption layer performs data encryption, and the compression layer performs data compression; wherein the positioning system will contain a number of positioning modules dependant on the carrier, sub-carrier, and mission profile; wherein the environment detection module to obtain environment information from a variety of sensor packages; wherein the synergy module integrates local environment data with environment information collected from the environment detection module; wherein the central control system or onboard data processing software processes the position, navigation, and environment information; wherein the route maintenance module integrates environment information from the environment detection module and synergy module; and wherein the communication between the carriers and sub-carriers is conducted between a control module onboard a carrier and a control sub-module onboard a sub-carrier.

In another aspect of the disclosed embodiments the positioning modules for the positioning system may be radio, sonar, autonomous (relying on internal sensor packages and onboard data processing software), and so forth.

In another aspect of the disclosed embodiments the sensor packages for the environment detection module may be optical, laser, radar, and so forth.

In another aspect of the disclosed embodiments the navigation module includes navigation algorithms.

In another aspect of the disclosed embodiments a carrier platform is an unmanned surface vehicle (USV).

In another aspect of the disclosed embodiments an aerial sub-carrier is an unmanned aerial vehicle (UAV).

In another aspect of the disclosed embodiments a water-surface sub-carrier is an unmanned surface vehicle (USV).

In another aspect of the disclosed embodiments a water-surface sub-carrier is a buoy.

In another aspect of the disclosed embodiments an underwater sub-carrier is a remotely operated underwater vehicle (ROV).

What is claimed is:

1. A deployment and retrieval system for unmanned sub-carriers, the system comprising:
one or more carrier platforms, each carrier platform comprising:
an array of sensors, the array of sensors including a GPS module;
a wireless communications module;
propulsion and steering means;
one or more docking stations for holding, deploying, or retrieving an unmanned sub-carrier; and
a controller equipped with navigation and positioning modules configured to autonomously navigate the carrier platform across a water body surface;
one or more unmanned sub-carriers, each sub-carrier being docked on a carrier platform and comprising:
an array of sensors, the array of sensors;
a wireless communications module;
propulsion and steering means; and
a controller equipped with navigation and positioning modules configured to autonomously navigate the sub-carrier and carry out operations in a marine environment;
and
an intelligent central control system, the central control system comprising one or more servers in wireless communication with each of the one or more carrier platforms and one or more of the sub-carriers, and being configured to receive navigation, positioning, and mission data from the one or more carrier platforms and sub-carriers and to coordinate the movements and operations of the one or more carrier platforms and sub-carriers.

2. A deployment and retrieval system according to claim 1, wherein the one or more sub-carriers comprise aerial drone sub-carriers in the form of unmanned aerial vehicles, UAVs.

3. A deployment and retrieval system according to claim 1, wherein the one or more sub-carriers comprise water surface sub-carriers.

4. A deployment and retrieval system according to claim 3, wherein the water surface sub-carriers include unmanned surface vehicles, USVs.

5. A deployment and retrieval system according to claim 3, wherein the water surface sub-carriers include smart buoys.

6. A deployment and retrieval system according to claim 1, wherein the one or more sub-carriers comprise underwater carriers in the form of remotely operated vehicles, ROVs.

7. A deployment and retrieval system according to claim 1, wherein the intelligent central control system comprises a data rendering module configured to provide real time mission data displays and tracking information displays for the carrier platforms and sub-carriers on a user interface.

8. A deployment and retrieval system according to claim 1, wherein the intelligent central control system comprises a data analysis module configured to track and log the routes and operations of the carrier platforms and sub-carriers based on the navigation, positioning, and mission data received and to predict potential problems and intelligently co-ordinate said carrier platforms and sub-carriers accordingly.

9. A deployment and retrieval system according to claim 1, wherein one or more of the carrier platforms comprise nest docking stations for deploying and retrieving aerial drones.

10. A deployment and retrieval system according to claim 1, wherein one or more of the carrier platforms comprise small vessel docking stations for deploying and retrieving unmanned surface vehicle sub-carriers.

11. A deployment and retrieval system according to claim 1, wherein one or more of the carrier platforms comprise underwater cages for deploying and retrieving underwater sub-carriers.

12. A deployment and retrieval system according to claim 1, wherein the central control system includes an interface where an operator may input instructions for any one of: inputting tasks, controlling the level of automation, and automating tasks of the carrier platforms and sub-carriers.
